(19) United States
(12) Patent Application Publication
(10) Pub. No.: US 2010/0189034 A1
(43) Pub. Date: Jul. 29, 2010

(54) WIRELESS COMMUNICATION APPARATUS AND SERVER APPARATUS

(75) Inventors: Chizuko Nagasawa, Yokohama-shi (JP); Kugo Morita, Yokohama-shi (JP)

Correspondence Address: MORRISON & FOERSTER LLP, 12531 HIGH BLUFF DRIVE, SUITE 100, SAN DIEGO, CA, 92130-2040, US

(73) Assignee: Kyocera Corporation, Kyoto (JP)

(21) Appl. No.: 12/665,926

(22) PCT Filed: Jun. 20, 2008
(86) PCT No.: PCT/JP2008/061349

§ 371 Date: Mar. 9, 2010

(30) Foreign Application Priority Data
Jun. 22, 2007 (JP) 2007-165334

(51) Int. Cl. H04W 40/00; H04L 12/66

(52) U.S. Cl. 370/328; 370/352

(57) ABSTRACT

Each of wireless communication terminals UA10 and UA20, capable of using a plurality of different wireless communication systems in accordance with the present invention, are provided with a transmission unit 110 for transmitting a call request including information on a condition of a wireless communication system desired by a calling side by use of a predetermined wireless communication system and a control unit 120 for controlling, when information that the called side uses the wireless communication system not satisfying the condition of the wireless communication system desired by the calling side is received in response to the call request transmitted by the transmission unit 110, to retransmit the call request based on the received information on the wireless communication system used by the called side by use of another wireless communication system different from the predetermined wireless communication system.

### CROSS REFERENCE TO RELATED APPLICATION

This application claims priority to and the benefit of Japanese Patent Application No. 2007-165334 (filed on Jun. 22, 2007), the entire contents of which are incorporated herein by reference.

### TECHNICAL FIELD

The present invention relates to a wireless communication apparatus (wireless communication terminal) and a server apparatus for performing call control of communication between wireless communication apparatuses of a calling side and a called side.

### BACKGROUND ART

SIP (Session Initiation Protocol) is a standard defined as one of call control protocols achieving call control such as a connection request with a real-time application of an internet phone based on VoIP (Voice over Internet Protocol). (For example, see Non-Patent Document 1.)

SIP was used originally for VoIP communication between computers such as personal computers and servers connected via a wired network on the internet. In recent years, however, a SIP server of wireless carriers (operators) supporting SIP and a wireless communication terminal (apparatus) have been developed, as digitalization of and adoption of IP technology to wireless communication equipment has been enhanced. Moreover, recent development of wireless communication technology enables a single wireless communication terminal to be provided with a plurality of wireless communication devices connectable to different wireless communication systems (wireless communication networks). Typical applications are PDA, PC and a cellular phone provided with a first wireless communication device connectable to a cellular phone network and a second wireless communication device connectable to a station of a wireless LAN such as WiFi and WiMAX, or MAN (Metropolitan Area Network).

Non-Patent Document 1: the website at http://www.ietf.org/rfc/rfc3261.txt (a document of RFC defining SIP)

### SUMMARY OF INVENTION

### Technical Problem

The SIP technology, however, was originally intended for use in a wired communication network, not in a wireless communication network in which bandwidth and communication quality change momentarily. In addition, the SIP technology was not intended for use in the wireless communication apparatus connectable to a plurality of wireless communication networks. Accordingly, the SIP technology in the wired communication network on the internet has been developed, while the SIP technology on the premises of communication environments across a plurality of different kinds of wireless networks has been underdeveloped.

FIG. 17 shows a configuration diagram of a wireless communication network of the conventional art. As shown in the figure, serving as a server or a gateway are a SIP server 30, a gateway (GW) 40, an SMS server 50 and GWs (or SIP servers) 60, 70. A wireless communication terminal UA1 and a wireless communication terminal UA2 serve as communication terminals of a calling side and a called side. Each terminal is connected to the servers via an operator packet network NET1, an operator circuit switching network NET2 and operator wireless communication packet networks RNET1 and RNET2.

In the constitution of the wireless communication network of the conventional art shown in the figure, for example, when the wireless communication terminal UA2 is called (instructed to connect to the packet network and to register) by an SMS (Short Message Service) message from the SMS server 50 of the circuit switching network corresponding to the operator wireless communication packet network RNET1 in response to a SIP connection request (calling: Invite) by the wireless communication terminal UA1, the wireless communication terminal UA2 performs a registration operation (Register) of SIP (Session Initiation Protocol) to the SIP server 30 via the packet switching network (in this case, RNET1) of the wireless communication network corresponding to the circuit switching network (that is, provided by the same carrier) which is called, and establish a call by performing SIP procedures thereafter. This method is on the premise that the wireless communication terminal can use only a single operator wireless communication packet network and a circuit switching network corresponding thereto. When the wireless communication terminal UA2, on the other hand, has a function to connect to two operator wireless communication packet networks RNET1 and RNET2 and thus has two options, SIP of the conventional art (that is, the wireless communication terminal UA2 having SIP) performs SIP registration via the network (the operator wireless communication packet network RNET1, in this example) corresponding to a path through which a message including a connection request (instruction to connect to the packet network and to register) has passed, as described above, and establishes a session with a caller/calling side (Calling Party) by use of the path of the packet network. In such a method for establishing the session, it does not always reflect a bandwidth corresponding to an application which a user at the calling side (Calling Party) desires to use or a wish and a liking of the user at the calling side, that is, a preference with regard to billing and the likes. That is, the preference of the user (Calling Party) sending the connection request is not considered at all.

Even if the calling side informs the called side of the preference (condition) it desires when sending a call establishment message (INVITE) of SIP, the called side may select a wireless communication system as much corresponding to the conditions of the calling side as possible, however, the calling side cannot know the wireless communication system selected by the called side until start of the session. In other words, a terminal of the calling side can know, only after establishment of the session, which wireless communication network a terminal of the called side can connect to (how much bandwidth the called side can use) or which wireless communication system is actually selected by the called side. It is thus not possible before establishment of the session for the calling side to know whether the terminal of the called side satisfies the preference informed by the calling side or to what degree the called side satisfies the preference if satisfying the preference. For example, when the terminal of the called side can connect only to a wireless communication network with a bandwidth not satisfying the required bandwidth, the terminal of the calling side cannot start the communication with the optimum bandwidth and the optimum wireless communication network in consideration of a current condition of wireless communication of the terminal of the called side.

For example, when the calling side is connectable to WiMAX (broadband) and EVDO (narrowband) while the called side is connectable to EVDO (narrowband), and the calling side selects WiMAX by prioritizing the bandwidth over billing rate and makes a call, the called side can connect only to EVDO regardless of the notified condition prioritizing the bandwidth. In such a case, therefore, regardless of the use of broadband WiMAX by the calling side, the narrowband EVDO selected by the called side causes a bottleneck, leading to waste of the bandwidth of WiMAX occupied and consumed by the calling side, because only the bandwidth of EVDO can be used in the session. It is thus an inefficient usage of bandwidth and waste of power. The wireless communication apparatus, in particular, is often carried constantly changing its wireless communication condition. For connection between the wireless communication apparatuses in such constantly changing environments of radio wave propagation, a need exists for a development of technology that provides the wireless communication connection efficient for both the called side and the calling side by selecting optimum wireless communication systems corresponding to the wireless communication conditions of both sides. There has thus been a problem that the wireless communication terminal of the caller/calling side (Calling Party) cannot efficiently use a plurality of connectable wireless communication systems (paths, networks and communication devices).

It is an object of the present invention to provide a technique (apparatus and method) to establish a wireless communication session between a calling side and a called side by selecting a wireless communication system optimum for both sides from the beginning, when a wireless communication terminal of the called side has a plurality of wireless communication systems (devices/paths, networks and bandwidths) as options. The present invention allows the called side to select a wireless communication system corresponding to a condition desired by the calling side and also the calling side to select the optimum wireless communication system in consideration of a condition of the called side based on a condition of the wireless communication system to which the called side is connectable.

### Solution to Problem

In order to achieve the above object, a wireless communication apparatus capable of using a plurality of different wireless communication systems in accordance with the present invention includes:

a transmission unit for transmitting a call request including information on a condition of a wireless communication system desired by a calling side by use of a predetermined wireless communication system; and

a control unit for controlling, when information indicating that a called side uses a wireless communication system not satisfying the condition of the wireless communication system desired by the calling side is received in response to the call request transmitted by the transmission unit, to retransmit the call request based on the received information on the wireless communication system used by the called side by use of another wireless communication system different from the predetermined wireless communication system.

In order to achieve the above object, a server apparatus in accordance with the present invention includes:

a reception unit for receiving a call request including information on a condition of a wireless communication system desired by a calling side;

a notification unit for notifying a called side of the information on the condition of the wireless communication system desired by the calling side in response to the call request received by the reception unit; and

a control unit for controlling, when information indicating that the called side uses a wireless communication system satisfying the condition of the wireless communication system desired by the calling side is received in response to notification by the notification unit, to transmit the call request to the called side.

The server apparatus in accordance with the present invention, wherein the control unit controls, when information indicating that the called side uses a wireless communication system not satisfying the condition of the wireless communication system desired by the calling side is received in response to notification by the notification unit, to notify the calling side of information on the wireless communication system used by the called side and not to transmit the call request to the called side.

### Advantageous Effects on Invention

According to the present invention, information to select a wireless communication system for connecting a calling side and a called side is exchanged via a predetermined wireless communication system before start of communication. Therefore, even when at least the calling side cannot connect to a circuit switching network, it is possible to start a session using a wireless communication system which is optimum for both the calling side and the called side according to conditions of wireless communication systems (wireless communication networks, bandwidth, rate and the likes) desired by users of the calling side and the called side.

### BRIEF DESCRIPTION OF DRAWINGS

FIG. 1 is a diagram illustrating a communication system 1 of a wireless communication network adopting a communication control method in accordance with a first embodiment of the present invention;

FIG. 2 is a diagram illustrating a communication system 2 of the wireless communication network adopting the communication control method in accordance with the first embodiment of the present invention;

FIG. 3 is a functional block diagram of a wireless communication terminal used in the wireless communication network in accordance with the present invention;

FIG. 4 is a functional block diagram illustrating a SIP server (call control server) used in the wireless communication network in accordance with the present invention;

FIG. 5 is a sequence diagram showing communication control performed until communication is started between a wireless communication terminal of a calling side and a wireless communication terminal of a called side in accordance with the communication control method of the first embodiment;

FIG. 6 is a flow chart showing call control performed by the SIP server in accordance with the communication control method of the first embodiment;

FIG. 7 is a table exemplifying a register memory table used for the call control by the SIP server in accordance with the communication control method of the first embodiment;

FIG. 8 is a diagram exemplifying a call request (INVITE) transmitted by the wireless communication terminal in accordance with the communication control method of the first embodiment;

FIG. 9 is a table exemplifying a desired call memory table used by the SIP server to store a desired call of the wireless communication terminal in accordance with the communication control method of the first embodiment;

FIG. 10 is a diagram illustrating a configuration of an SMS server used for the wireless communication system adopting the communication control method in accordance with the first embodiment;

FIG. 11 is a flow chart showing the call control by the SIP server in accordance with the communication control method of the first embodiment;

FIG. 12 is a diagram exemplifying a user selection screen displayed by the wireless communication terminal of the calling side in accordance with the communication control method of the first embodiment;

FIG. 13 is a sequence diagram showing another communication control performed until communication is started between the wireless communication terminal of the calling side and the wireless communication terminal of the called side in accordance with the communication control method of the first embodiment;

FIG. 14 is a diagram exemplifying a user selection screen displayed by the wireless communication terminal of the calling side in accordance with the communication control method of the first embodiment;

FIG. 15 is a sequence diagram showing still another communication control performed until communication is started between the wireless communication terminal of the calling side and the wireless communication terminal of the called side in accordance with the communication control method of the first embodiment;

FIG. 16 is a sequence diagram showing still another communication control performed until the communication is started between the wireless communication terminal of the calling side and the wireless communication terminal of the called side in accordance with the communication control method of the first embodiment; and

FIG. 17 is a diagram exemplifying a configuration of a wireless communication network of the conventional art.

### DESCRIPTION OF EMBODIMENTS

Before a detailed description of a principle and a configuration of the present invention, a typical sequence of the present invention will be briefly described. Although the present invention is intended for a variety of types of wireless communication apparatuses and communication control methods therefor, a wireless communication terminal, a typical wireless communication apparatus, is described as an example.

(1) In order to call with a real-time application from a wireless communication terminal (apparatus) having a plurality of wireless communication network systems (devices) to another wireless communication terminal (apparatus), the wireless communication terminal of the calling side notifies the wireless communication terminal of the called side of a name of a wireless communication network which the calling side can connect to and a bandwidth required for the real-time application. In consideration of a wireless communication network to which the wireless communication terminal of the called side can connect, the wireless communication network to which the calling side can connect and the bandwidth required for the real-time application, the wireless communication terminal of the called side selects a wireless communication network for the called side and notifies the wireless communication terminal of the calling side of the wireless communication network of the called side selected and a name of the wireless communication network to which the called side can connect, as a response to the calling side. Then, based on information notified from the called side, the wireless communication network to which the calling side can connect and the bandwidth required for the application, the wireless communication terminal of the calling side selects a wireless communication network to connect to and performs necessary SIP procedures on the wireless communication networks selected by the calling side and the called side, so as to reach a communication state.

(2) Between the terminal of the calling side and the terminal of the called side, notification of the name of a wireless network to which the calling side can connect and the bandwidth required for the real-time application desired by the calling side and notification of the network selected are performed via a SIP server. In addition, after selecting the network to use, the terminal of the called side connects to the network selected and registers to the SIP server, and then the SIP server notifies the wireless communication terminal of the calling side of a name of the network registered.

(3) Being notified of the wireless network to which the calling side can connect and the required bandwidth at the (1), the wireless communication terminal of the called side, if there are a plurality of wireless networks satisfying the condition of the bandwidth at calling and called sides, selects a wireless network which charges a user at the lowest rate.

(4) At the above (2), the wireless communication terminal of the calling side transmits a notification of a name of a network which the calling side desires the called side to connect to, along with the name of the wireless network to which the calling side can connect and the required bandwidth for the desired real-time application.

(5) When receiving the notification from the wireless communication terminal of the calling side at the above (4), the SIP server, if the communication terminal of the called side connects to the same network as the network desired by the calling side and registers therewith, performs necessary SIP procedures without transmitting the notification to the communication terminal of the calling side, and reaches the communication state.

(6) When receiving the notification from the wireless communication terminal of the calling side at the above (4), the SIP server stores a combination of the name of the desired network notified, the wireless communication terminal of the calling side and the wireless communication terminal of the called side. When the communication terminal of the called side connects and registers, the SIP server, if the communication terminal of the called side connects to the same network as the desired network notified by the communication terminal of the calling side and registers therewith, performs necessary SIP procedures without transmitting the notification to the communication terminal of the calling side, and reaches the communication state.

(7) In a case where the bandwidth of the wireless network of the called side selected at the above (1) does not satisfy the required bandwidth, the terminal of the calling side inquires a user to select either switching to another application which requires a narrow bandwidth or cancellation of the call to the wireless communication terminal of the called side. When cancellation is selected, the terminal of the calling side notifies the terminal of the called side of cancellation and ends the process. When switching to another application is selected, the terminal of the calling side switches to a wireless network corresponding to the network of the terminal of the called side, changes to an application usable in the bandwidths of the wireless networks of the calling side and the called side, and performs necessary SIP procedures.

(8) In a case where the rate increases by switching the network of the calling side to correspond to the wireless network of the called side selected at the above (1), the terminal of the calling side shows the rate to the user and inquires the user to select switching of the wireless network, no switching of the wireless network or cancellation of the call to the wireless communication terminal of the called side. When cancellation is selected, the terminal of the calling side notifies the terminal of the called side of cancellation and ends the process. When switching is selected, the terminal of the calling side switches to a wireless network corresponding to the wireless network of the terminal of the called side, while performing necessary SIP procedures without switching when no switching is selected.

(9) At the above (1), the wireless communication terminal of the calling side notifies the called side of a policy with regard to a selection of the wireless network, together with the name of the wireless network to which the calling side can connect and the required bandwidth for the desired real-time application. The policy indicates whether to prioritize a bandwidth which the calling side desires the wireless communication network of the called side to achieve or to prioritize a lower rate. The communication terminal of the called side selects a wireless network to use based on the policy notified with regard to the selection of the wireless network.

A preferred embodiment of the present invention will now be described with reference to the accompanying drawings.

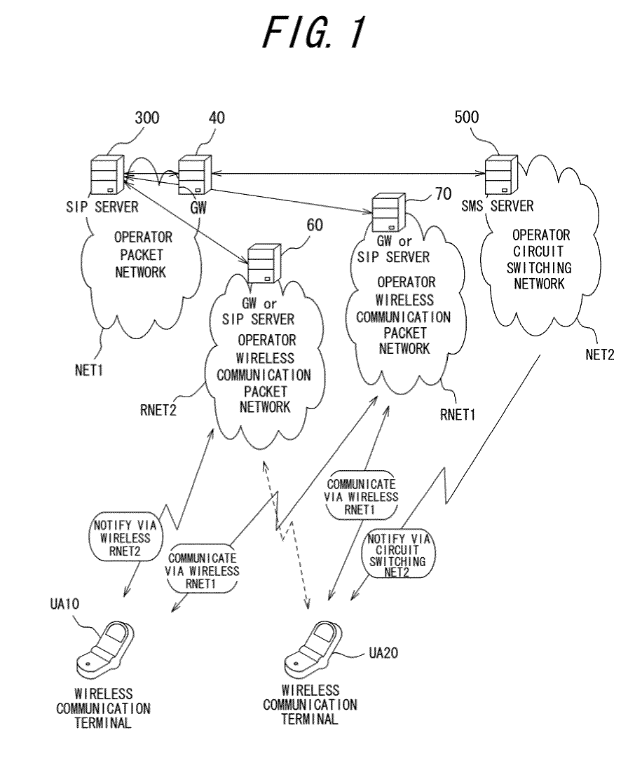

FIG. 1 is a diagram illustrating a communication system 1 of a wireless communication network adopting a communication control method in accordance with a first embodiment of the present invention. As shown in FIG. 1, serving as servers or gateways are a SIP server 300, a gateway (GW) 40, an SMS server 500, a GW (or SIP server) 60, a GW (or SIP server) 70. The SIP server 300 functions as a call control server, while the SMS server 500 functions as a message transmission server. Wireless communication terminals UA (User Agent) 10 and UA20 serve as communication terminals of the calling side and the called side, respectively. These wireless communication terminals are connected to servers or GWs described above via an operator packet network NET1, an operator circuit switching network NET2 and operator wireless communication packet networks RNET1, RNET2.

The wireless communication terminal UA10 is a multi-mode terminal capable of connecting to the operator wireless communication packet network RNET1 and the operator wireless communication packet network RNET2, while the wireless communication terminal UA20 is a multi-mode terminal capable of connecting to the operator wireless communication packet network RNET1, the operator wireless communication packet network RNET2 and the operator circuit switching network NET2. The operator wireless communication packet network RNET2 is a network with a broader bandwidth than that of the operator wireless communication packet network RNET1. When being on standby, the wireless communication terminal UA10 is connected to one of the operator wireless communication packet networks and exists in a dormant state. The wireless communication terminal UA20 is on standby in the operator circuit switching network NET2 and not connected to the operator wireless communication packet network RNET1 and the operator wireless communication packet network RNET2.

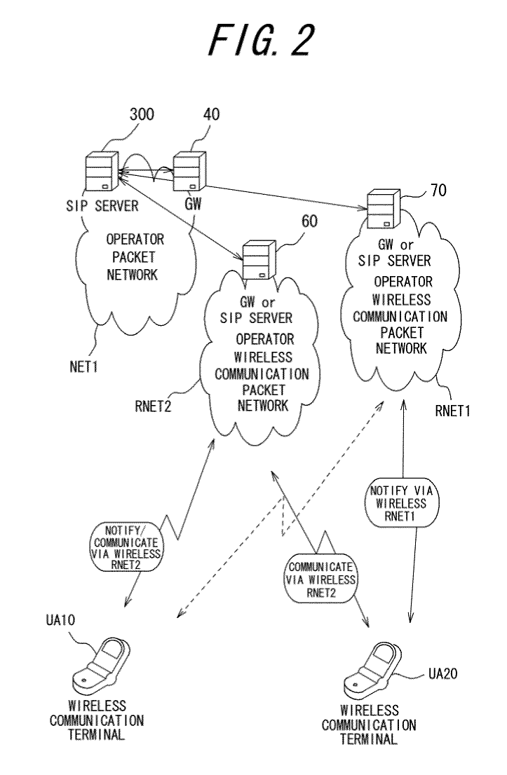

FIG. 2 is a diagram illustrating a communication system 2 of the wireless communication network adopting the communication control method in accordance with the first embodiment of the present invention. The communication system 2 omits the SMS server 500 and the operator circuit switching network NET2 in the communication system 1. As shown in FIG. 2, both of the wireless communication terminals UA10 and UA20 are multi-mode terminals capable of connecting only to the operator wireless communication packet network RNET1 and the operator wireless communication packet network RNET2. The operator wireless communication packet network RNET2 is a network with a broader bandwidth than that of the operator wireless communication packet network RNET1. Normally, when being on standby, the wireless communication terminal UA10 and the wireless communication terminal UA20 have been connected to either one of the operator wireless communication packet networks and registered to the SIP server 300.

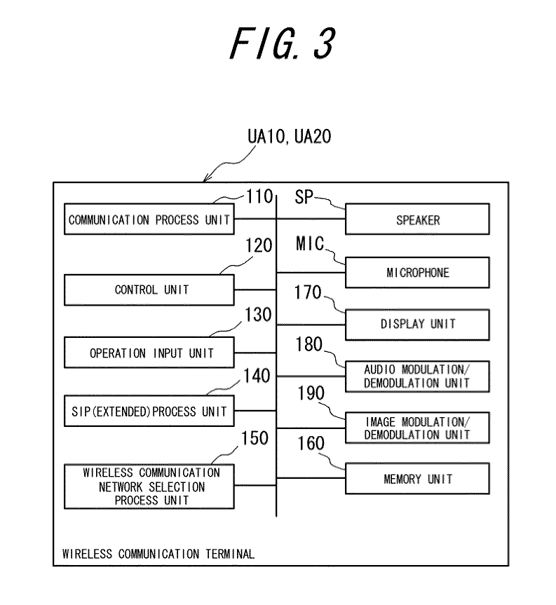

FIG. 3 is a functional block diagram of a wireless communication terminal used for the wireless communication network in accordance with the present invention. As shown in FIG. 3, each of the wireless communication terminals UA10 and UA20 is provided with a communication process unit 110, a control unit (CPU, processor) 120, an operation (preference) input unit 130, a SIP (an extended) process unit 140, a wireless communication network selection process unit 150, a memory unit 160, a speaker SP, a microphone MIC, a display unit 170, an audio modulation/demodulation unit 180, and an image modulation/demodulation unit 190. The communication process unit 110 functions as a transmission unit and a reception unit to transmit and receive a call establishment message (INVITE message) via the wireless communication network selection process unit 150 and the SIP process unit 140 and the like. Moreover, the communication process unit 110 functions as a transmission unit and a reception unit to perform transmission and reception of an inquiring message (SMS message) with the packet switching network via the wireless communication network selection process unit 150. (The wireless communication terminal UA10 covers an apparatus incapable of transmitting and receiving SMS messages.)

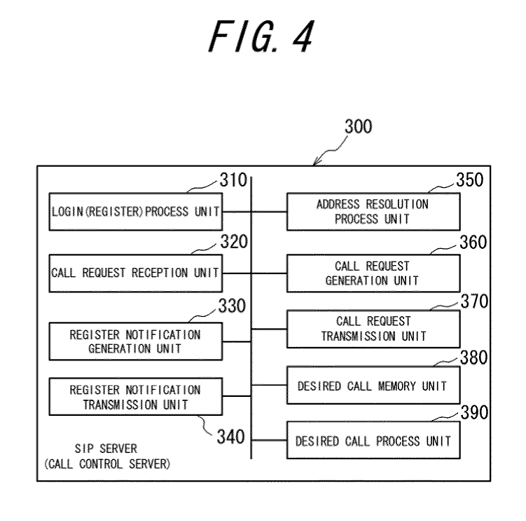

FIG. 4 is a functional block diagram of the SIP server (call control server) used for the wireless communication network in accordance with the present invention. As shown in FIG. 4, the SIP server 300 is provided with a login (register) process unit 310, a call request reception unit 320, a register notification generation unit 330, a register notification transmission unit 340, an address resolution process unit 350, a call request generation unit 360, a call request transmission unit 370, a desired call memory unit 380 and a desired call process unit 390. The login (register) process unit 310 receives a login (Register) request from a terminal and performs necessary procedures. The call request reception unit 320 receives the call establishment message (INVITE message) containing information on preference of the calling side to call the called side. In order to transmit the call establishment message received by the call request reception unit 320 to the called side, the call request generation unit 360 generates call request information including information indicating that the call establishment message is received and a desired condition (preference information) included in the call establishment message. The call request transmission unit 370 transmits the call request information generated to the SMS server (message transmission server) or transmits the call request information generated based on SIP protocol to the terminal of the called side. The desired call memory unit 380 stores the desired condition of a call (desired wireless communication network, application, rate and the likes) received from the wireless communication terminal UA10. The desired call process unit 390 performs necessary procedures based on the desired condition of a call received from the wireless communication terminal UA10.

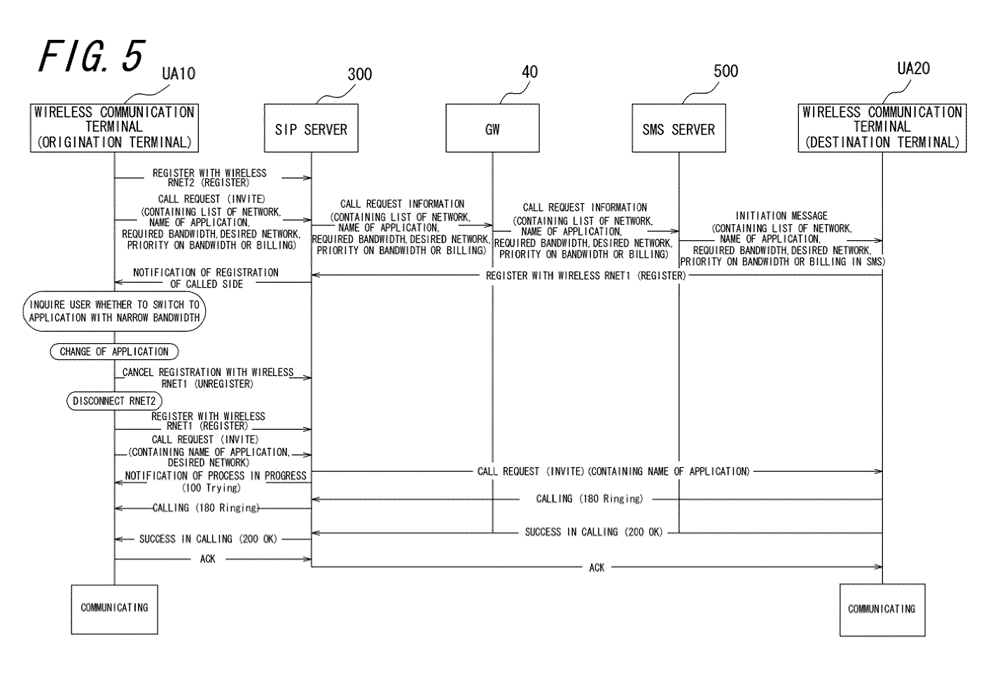

FIG. 5 is a sequence diagram showing communication control in accordance with the communication control method of the first embodiment when the wireless communication terminal of the calling side (an origination terminal) UA10 calls the wireless communication terminal of the called side (a destination terminal) UA20 capable of connecting to the circuit switching network and starts communication with the real-time application. FIG. 5 shows a case where the wireless communication terminal of the called side (the destination terminal) UA20 selects a wireless communication network with an insufficient bandwidth.

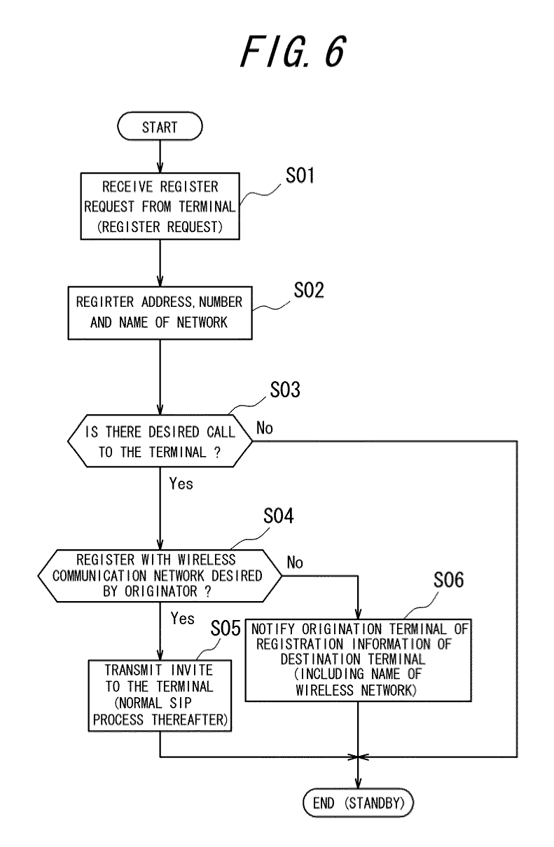

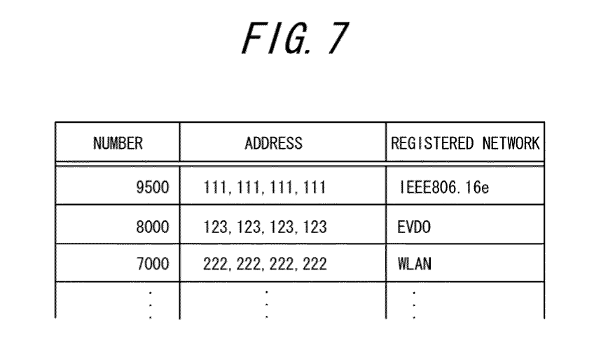

First, the origination terminal UA10 connects to (uses) the operator wireless communication packet network RNET2 (referred to as a wireless network RNET2, hereinafter) and registers to the SIP server 300. In this case, the SIP server 300 follows the process shown as steps S01 to S03 in FIG. 6. That is, when receiving a register request from the terminal (the origination terminal UA10, in this case) at the step S01 in FIG. 6, the SIP server 300 registers an address, a number and a name of the network of the terminal in a register memory table exemplified in FIG. 7, at the next step S02. Then, since it is determined at the step S03 that there is no desired call to the terminal to communicate with at this point, the process follows an arrow of “No” and ends to reach a standby state.

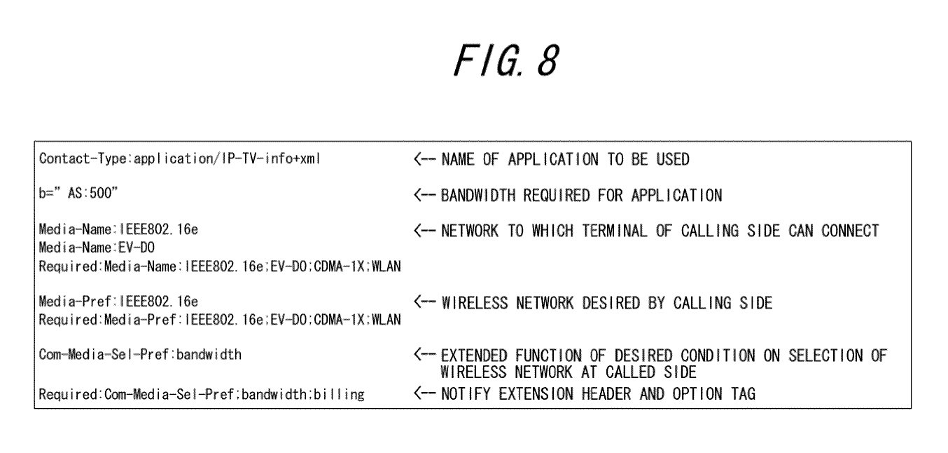

Next, the origination terminal UA10 transmits a call request (INVITE) for the destination terminal UA20 to the SIP server 300. As exemplified in FIG. 8, information included in the call request (INVITE) is:
a list of wireless networks to which the wireless communication terminal of the calling side can connect: wireless networks RNET1, RNET2
a name of the application: videophone
a bandwidth required for the application: 500 kbps
a wireless network desired by the calling side: wireless network RNET2
information on whether “priority on the bandwidth” or “priority on low rate”: “priority on the bandwidth”

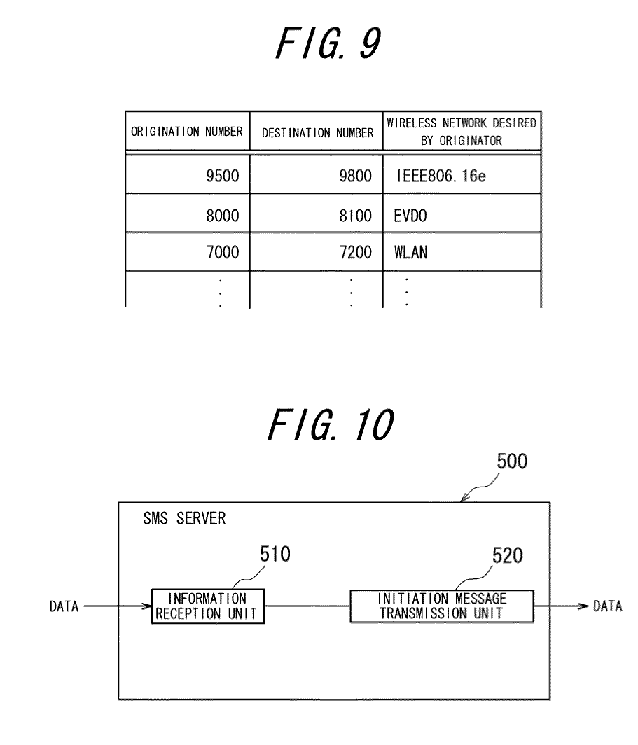

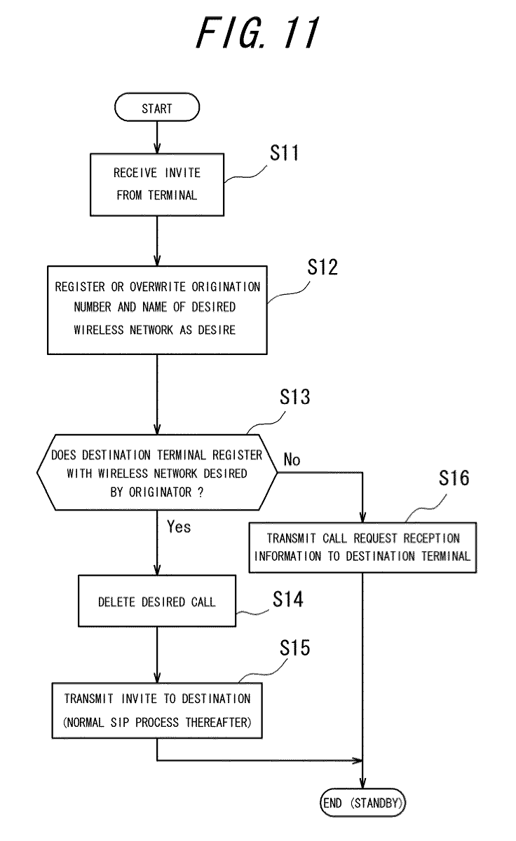

When the SIP server 300, upon receiving the call request (INVITE), confirms that the destination terminal UA20 has not registered yet, the SIP server 300 stores an origination number, a destination number and the wireless network desired by the calling side (originator) as a desired call in a desired call memory table (its configuration is exemplified in FIG. 9), and then transmits an initiation message of SMS from the SMS server 500 (its configuration is exemplified in FIG. 10) to the destination terminal UA20 via the GW 40. This initiation message also contains the same information as contained in the call request (INVITE). In this case, the SIP server 300 follows the process shown as steps S11 to S13 and then S16 in FIG. 11. That is, when receiving the call request (INVITE) from the terminal (the origination terminal UA10, in this case) at the step S11 in FIG. 11, the SIP server 300 registers or overwrites the combination of the origination number and the destination number of the call request (INVITE), and the name of the wireless network desired by the originator, as a desired call in the desired call memory table, at the next step S12. At the following step S13, it is determined whether the destination terminal has registered with the wireless network desired by the originator and, if the destination terminal has not registered with the desired wireless network, the process proceeds to the step S16, where information on the call request is transmitted to the destination terminal via the SMS server 500, and the process ends to reach the standby state.

It is to be noted that, in a case where the wireless network of the wireless communication terminal of the called side UA20 which has already registered to the SIP server 300 is the wireless network desired by the origination terminal UA10 at the determination of the step S13, the SIP server 300 transmits the call request (INVITE) to the destination terminal. In this case, the SIP server 300 follows the process shown as an arrow Yes of step S13, steps S14 and S15 in FIG. 11. Specifically, the desired call is deleted at the step S14, which is proceeded when the determination at the step S13 is Yes in FIG. 11, and the SIP server 300 transmits the call request (INVITE) to the destination terminal at the next step S15 and then proceeds normal SIP procedures thereafter. In addition, in a case where the destination terminal UA20 is not capable of connecting to the operator circuit switching network (NET2), information on the call request (INVITE) may be included in paging information of the operator wireless communication packet network (RNET1 or RNET2) so as to call the destination terminal. Moreover, in a case where the destination terminal is a PC or the like connected to the internet and has already registered to the SIP server 300, information on the call request (INVITE) may be transmitted to an address of the terminal.

When receiving the initiation message from the SMS server 500, the destination terminal UA20 selects the operator wireless communication packet network RNET1 as a wireless network to which the destination terminal UA20 connects based on the information in the initiation message and a wireless network to which the destination terminal UA20 can currently connect, connects to the wireless network selected and then registers to the SIP server 300. When confirming that the destination terminal UA20 connects to the operator wireless communication packet network RNET1 (the wireless network different from the one desired by the origination terminal UA10) and registers therewith at the registration, the SIP server 300 informs the origination terminal UA10 of that the destination terminal UA20 has registered with the operator wireless communication packet network RNET1. In this case, since the destination terminal UA20 connects to the wireless network different from the one desired by the origination terminal UA10 and registers therewith, the SIP server 300 controls so as not to transmit the call request (INVITE) to the destination terminal.

In this case, the SIP server 300 follows the process shown as step S01, step S02, step S03, arrow Yes, step S04, an arrow No, and then step S06 in FIG. 6. That is, when receiving a register request (Register) from a terminal (the destination terminal UA20, in this case) at the step S01 in FIG. 6, the SIP server 300 registers the address, the number and the name of the network of the destination terminal UA20 in a register memory table exemplified in FIG. 7, at the next step S02. Then, since there is a desired call to the terminal to communicate with, it is determined as Yes at the step S03 and proceeds to the step S04. At the step S04, it is determined whether the destination terminal UA20 registers with the wireless network (RNET2) desired by the origination terminal UA10, and since it is determined as No, the process proceeds to the step S06. At the step S06, the origination terminal UA10 is notified of registration information (including the name of the wireless network registered) of the destination terminal UA20. In a case where the destination terminal UA20 connects to the wireless network desired by the origination terminal UA10 and registers therewith, it is determined as Yes at the step S04 and proceeds to the step S05, where the SIP server 300 transmits the call request (INVITE) to the destination terminal and performs normal SIP processes thereafter to start communication.

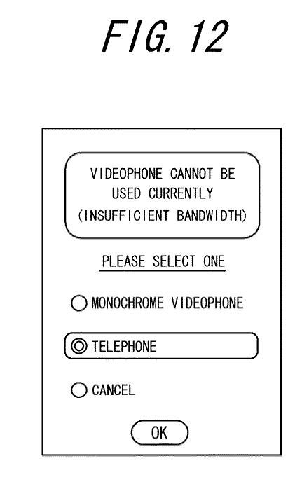

When the origination terminal UA10 informed of registration information stated above, confirms that the wireless network (RNET1) does not have enough bandwidth and that the rate of the wireless network (RNET1) is lower than that of the wireless network (RNET2), the origination terminal UA10 displays a user selection screen, exemplified in FIG. 12, so as to inquire the user to select either switching to another application (monochrome videophone or telephone) which requires a narrow bandwidth to communicate or cancellation. When the user views the user selection screen and selects switching to another application to perform communication, the origination terminal UA10 disconnects the wireless network (RNET2), connects to the wireless network (RNET1), registers to the SIP server 300, and then transmits (retransmits) the call request (INVITE) for the destination terminal UA20. When the call request is retransmitted, a previous call request (INVITE) is cancelled by the SIP server 300. Written in the call request (INVITE) are:
a name of the application: monochrome videophone
a wireless network desired by the calling side: wireless network RNET1

In a case where the user selects not to switch the application at the inquiry, the origination terminal UA10 transmits (retransmits) the same call request (INVITE) on the wireless network (RNET2). In a case where cancellation is selected at the above inquiry, the destination terminal UA20 is notified of the cancellation via the SIP server 300. When being notified, the destination terminal UA 20 disconnects the wireless network RNET1 as necessary.

When confirming that the wireless network (wireless network RNET1) with which the destination terminal UA20 registers corresponds to the wireless network (wireless network RNET1) desired by the origination terminal UA10, the SIP server 300 transmits the call request (INVITE) to the destination terminal UA20. In this case, the SIP server 300 follows the process shown as step S11, step S12, step S13, Yes, step S14, and then step S15 in FIG. 11. Subsequently, the origination terminal UA10 and the destination terminal UA20 perform SIP procedures necessary for the call shown in FIG. 5 to start the communication of the real-time application.

According to the communication control method shown in FIG. 5, the wireless communication terminal of the called side UA20 is notified of information to select a wireless communication system for connecting the calling side and the called side from the SIP server 300 via the circuit switching network before start of communication even if the wireless communication terminal UA10 of the calling side cannot connect to the circuit switching network. Therefore, it is possible to be achieved even if the wireless communication terminal of the calling side UA10 has no capability (function) to connect to the circuit switching network. In addition, since switching of a wireless network of the wireless communication terminal of the calling side UA10 is also performed between the SIP server 300 and the terminal before start of the communication in response to the notification from the wireless communication terminal of the called side UA20, it is possible to communicate by use of the optimum wireless communication system (wireless network RNET1, in this case) according to the conditions (wireless communication network, bandwidth, rate and the likes) of the wireless communication systems desired by the users at the calling side and the called side.

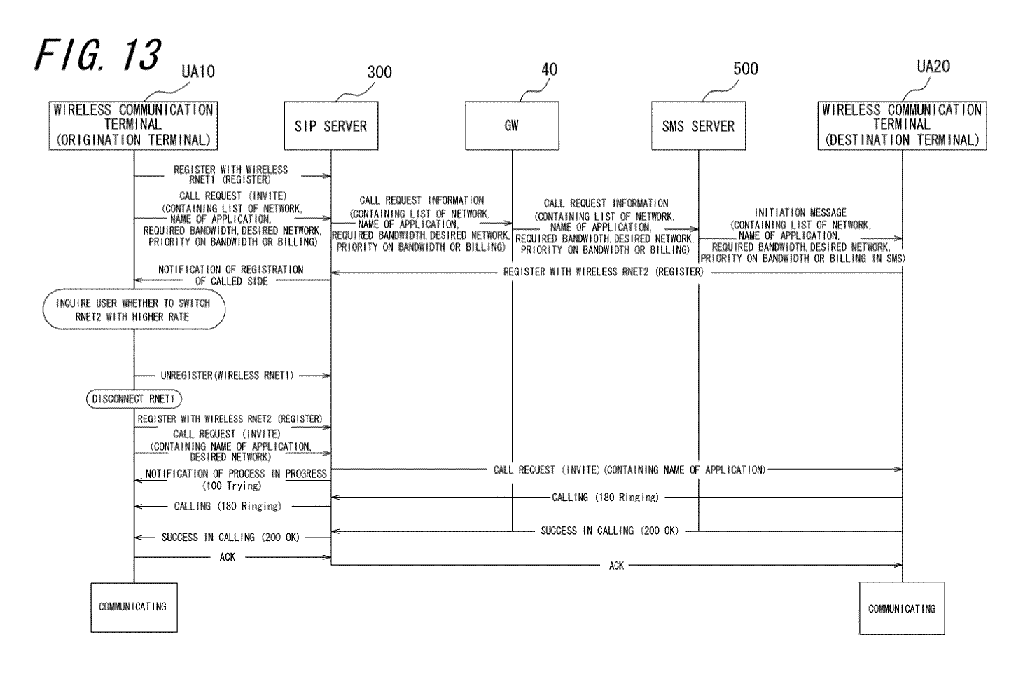

FIG. 13 is a sequence diagram showing communication control in accordance with the communication control method of the first embodiment when the wireless communication terminal of the calling side (origination terminal) UA10 calls the wireless communication terminal of the called side (destination terminal) UA20 capable of connecting to the circuit switching network and starts the communication with the real-time application. FIG. 13 shows a case where the rate increases when the wireless communication terminal of the calling side (origination terminal) UA10 switches to a wireless network corresponding to a wireless network selected by the wireless communication terminal of the called side (destination terminal) UA20.

First, the origination terminal UA10 connects to (uses) the operator wireless communication packet network RNET1 (referred to as a wireless RNET1, hereinafter) and registers to the SIP server 300. In this case, the SIP server 300 follows the process shown as steps S01 to S03 in FIG. 6. Specifically, when receiving the register request from a terminal (the origination terminal UA10, in this case) at the step S01 in FIG. 6, the SIP server 300 registers the address, the number and the name of the network of the terminal in the register memory table exemplified in FIG. 7, at the next step S02. Then, since it is determined at the step S03 that there is no desired call to the terminal to communicate with at this point, the process follows an arrow of “No” and ends to reach the standby state.

Next, the origination terminal UA10 transmits the call request (INVITE) for the destination terminal UA20 to the SIP server 300. The call request (INVITE) is generated based on the format shown in FIG. 8 to include the following contents:
a list of wireless networks to which the wireless communication terminal of the calling side can connect: wireless networks RNET1, RNET2
a name of the application: telephone
a bandwidth required for the application: 50 kbps
a wireless network desired by the calling side: wireless network RNET1
information on whether “priority on the bandwidth” or “priority on low rate”: “priority on the bandwidth”

When the SIP server 300, upon receiving the call request (INVITE), confirms that the destination terminal UA20 has not registered yet, the SIP server 300 stores the origination number, a destination number and the wireless network desired by the calling side (originator) as a desired call in the desired call memory table (its configuration is based on FIG. 9), and then transmits an initiation message of SMS from the SMS server 500 (its configuration is exemplified in FIG. 10) to the destination terminal UA20 via the GW 40. This initiation message contains the same information as contained in the call request (INVITE). In this case, the SIP server 300 follows the process shown as steps S11 to S13 and S16 in FIG. 11. That is, when receiving the call request (INVITE) from the terminal (the origination terminal UA10, in this case) at the step S11 in FIG. 11, the SIP server 300 registers or overwrites the combination of the origination number and the destination number of the call request (INVITE) and the name of the wireless network desired by the originator, as a desired call in the desired call memory table, at the next step S12. At the following step S13, it is determined whether the destination terminal has registered with the wireless network desired by the origination terminal and, if the destination terminal is not registered with the desired wireless network, the process proceeds to the step S16, where information on the call request is transmitted to the destination terminal via the SMS server 500, and the process ends to reach the standby state.

When receiving the initiation message from the SMS server 500, the destination terminal UA20 selects the operator wireless communication packet network RNET2 as the wireless network to which the destination terminal US20 connects based on the information in the initiation message and a wireless network to which the destination terminal UA20 can currently connect, connects to the wireless network selected and then registers to the SIP server 300. When confirming that the destination terminal UA20 connects to the operator wireless communication packet network RNET2 (the wireless network different from the one desired by the origination terminal UA10) and registers therewith at registration, the SIP server 300 informs the origination terminal UA10 of that the destination terminal UA20 has registered with the operator wireless communication packet network RNET2. In this case, since the destination terminal UA20 connects to the wireless network different from the one desired by the origination terminal UA10 and registers therewith, the SIP server 300 controls so as not to transmit the call request (INVITE) to the destination terminal.

In this case, the SIP server 300 follows the process shown as step S01, step S02, step S03, Yes, step S04, No, and then step S06 in FIG. 6. That is, when receiving the register request (REGISTER) from the terminal (the destination terminal UA20, in this case) at the step S01 in FIG. 6, the SIP server 300 registers the address, the number and the name of the network of the destination terminal UA20 in the register memory table exemplified in FIG. 7, at the next step S02. Then, since there is a desired call to the terminal to communicate with, it is determined as Yes at the step S03 and proceeds to the step S04. At the step S04, it is determined whether the destination terminal UA20 registers with the wireless network (RNET1) desired by the origination terminal UA10, and since it is determined as No, the process proceeds to the step S06. At the step S06, the origination terminal UA10 is notified of registration information (including the name of the wireless network registered) of the destination terminal UA20.

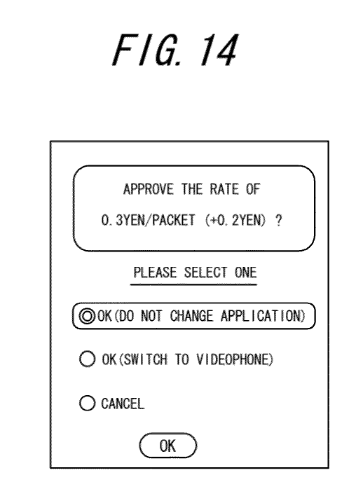

When the origination terminal UA10 informed of the registration information confirms that the rate of the wireless network (RNET2) is higher than that of the wireless network (RNET1) although the wireless network (RNET2) has enough bandwidth, the origination terminal UA10 displays a user selection screen exemplified in FIG. 14 so as to indicate the increased rate and to inquire the user to select cancellation, start of the communication without switching the application, or switching to the application with a broader bandwidth to communicate. When the user views the user selection screen and selects switching to the application with the broader bandwidth to perform the communication, the origination terminal UA10 disconnects the wireless network (RNET1), connects to the wireless network (RNET2), registers to the SIP server 300, and then transmits (retransmits) the call request (INVITE) for the destination terminal UA20. When the call request is retransmitted, the previous call request (INVITE) is cancelled by the SIP server 300. Written in the call request (INVITE) are:
the name of the application: videophone
the wireless network desired by the calling side: wireless network RNET2

When confirming that the wireless network (wireless network RNET2) with which the destination terminal UA20 registers corresponds to the wireless network (wireless network RNET2) desired by the origination terminal UA10, the SIP server 300 transmits the call request (INVITE) to the destination terminal UA20. In this case, the SIP server 300 follows the process shown as steps S11 to S13, Yes, step S14, and step S15 shown in FIG. 11. Subsequently, the origination terminal UA10 and the destination terminal UA20 perform SIP procedures necessary for the call shown in FIG. 13 to start the communication with the real-time application.

According to the communication control method shown in FIG. 13, the wireless communication terminal of the called side UA20 is notified of information to select a wireless communication system for connecting the calling side and the called side from the SIP server 300 via the circuit switching network before start of communication even if the wireless communication terminal UA10 of the calling side cannot connect to the circuit switching network. Therefore, it is possible to be achieved even if the wireless communication terminal of the calling side UA10 has no capability (function) to connect to the circuit switching network. In addition, since switching of a wireless network of the wireless communication terminal of the calling side UA10 is also performed between the SIP server 300 and the terminal before start of the communication in response to the notification from the wireless communication terminal of the called side UA20, it is possible to communicate by use of the optimum wireless communication system (wireless network RNET2, in this case) according to the conditions (wireless communication network, bandwidth, rate and the likes) of the wireless communication systems desired by the users at the calling side and the called side.

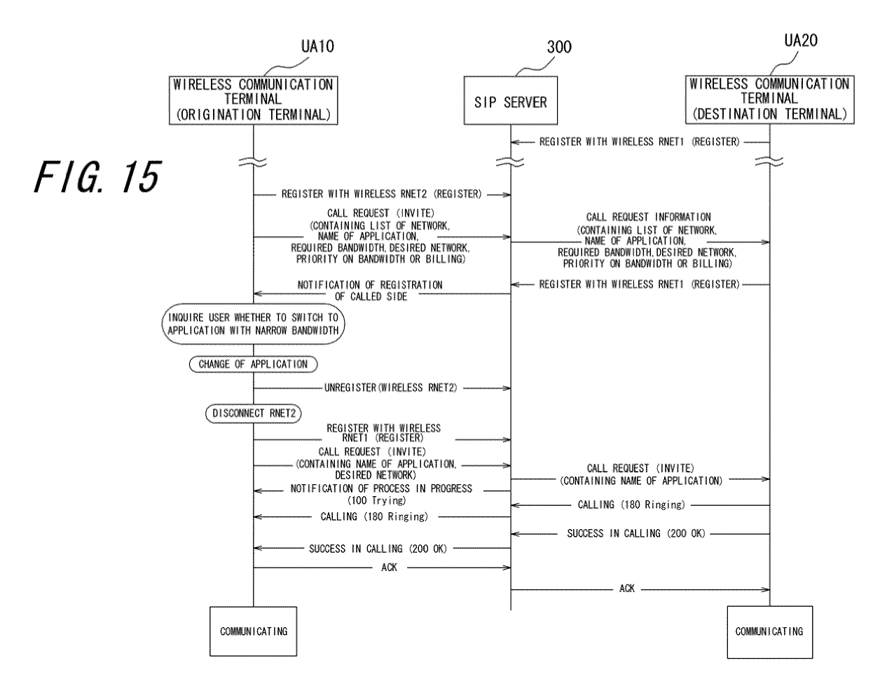

FIG. 15 is a sequence diagram showing communication control in accordance with the communication control method of the first embodiment when the wireless communication terminal of the calling side (origination terminal) UA10, which is incapable of connecting to the circuit switching network (including a case having no such function), calls the wireless communication terminal of the called side (destination terminal) UA20, in a case where the wireless communication terminal of the called side (destination terminal) UA20 is incapable of connecting to the circuit switching network (including a case having no such function) and registers to the SIP server 300 with the wireless network RNET1, and starts communication with the real-time application. FIG. 15 shows a case where the wireless communication terminal of the called side (destination terminal) UA20 selects a wireless communication network with an insufficient bandwidth.

First, the origination terminal UA10 connects to (uses) the wireless network RNET2 and registers to the SIP server 300. In this case, the SIP server 300 follows the process shown as the steps S01 to S03 in FIG. 6 and registers the address, the number and the name of the network of the terminal at the register memory table exemplified in FIG. 7. Next, the origination terminal UA10 transmits a call request (INVITE) for the destination terminal UA20 to the SIP server 300. As exemplified in FIG. 8, the call request (INVITE) includes the following information:
a list of wireless networks to which the wireless communication terminal of the calling side can connect: wireless networks RNET1, RNET2
a name of the application: videophone
a bandwidth required for the application: 500 kbps
a wireless network desired by the calling side: wireless network RNET2
information on whether “priority on bandwidth” or “priority on low rate”: “priority on bandwidth”

When the SIP server 300, upon receiving the call request (INVITE), confirms that although the destination terminal UA20 has registered, the wireless network (wireless network RNET1) to which the destination terminal UA20 connects is not the wireless network (wireless network RNET2) desired by the origination terminal UA10, the SIP server 300 stores an origination number, a destination number and a wireless network desired by the calling side (originator) as a desired call in the desired call memory table (a configuration of which is exemplified in FIG. 9). Then, the SIP server 300 follows the process shown as the steps S11 to S13, S16 shown in FIG. 11, and transmits the call request information to the destination terminal UA20. The same information as included in the call request (INVITE) is also included in the call request information.

When receiving the call request information from the SIP server 300, the destination terminal UA20 selects the wireless network RNET1 as a wireless network to which the destination terminal UA20 connects based on information in the call request information and the wireless network to which the destination terminal UA20 can currently connect, connects to the wireless network selected, and then registers to the SIP server 300. In this case, since the destination terminal UA20 selects the wireless network RNET1 and has already registered with the wireless network RNET1, the destination terminal UA20 registers to the SIP server 300 again. At this registration, when confirming that the destination terminal UA20 connects to the wireless network RNET1 (the wireless network different from the one desired by the origination terminal UA10) and registers therewith, the SIP server 300 informs the origination terminal UA10 of that the destination terminal UA20 registers with the wireless communication network RNET1. In this case, since the destination terminal UA20 connects to the wireless network different from the one desired by the origination terminal UA10 and registers therewith, the SIP server 300 controls so as not to transmit the call request (INVITE) to the destination terminal. It is to be noted that, as for the process of the destination terminal UA20, it is not necessary to reregister but may notify, as long as the SIP server 300 can detect that the destination terminal UA20 connects to the wireless network RNET1 and registers therewith in the above case.

When the origination terminal UA10 informed of the registration information confirms that the wireless network (RNET1) does not have enough bandwidth and charges a user at a lower rate than the wireless network (RNET2), the origination terminal UA10 displays the user selection screen, exemplified in FIG. 12, so as to inquire the user to select either switching to an application (monochrome videophone or telephone) which requires a narrow bandwidth to communicate or cancellation. When the user views the user selection screen and selects switching to the application to perform the communication, the origination terminal UA10 disconnects the wireless network (RNET2), connects to the wireless network (RNET1), registers to the SIP server 300, and then transmits (retransmits) a call request (INVITE) for the destination terminal UA20. When the call request is retransmitted, the previous call request (INVITE) is cancelled by the SIP server 300. Written in the call request (INVITE) are:
a name of the application: monochrome videophone
a wireless network desired by the calling side: wireless network RNET1

When confirming that the wireless network (wireless network RNET1) with which the destination terminal UA20 registers corresponds to the wireless network (wireless network RNET1) desired by the origination terminal UA10, the SIP server 300 transmits the call request (INVITE) to the destination terminal UA20. In this case, the SIP server 300 follows the process shown as step S11, step S12, step S13, Yes, step S14, and then step S15 in FIG. 11. Subsequently, the origination terminal UA10 and the destination terminal UA20 perform SIP procedures necessary for the call shown in FIG. 15 to start the communication with the real-time application.

According to the communication control method of FIG. 15, even when both of the wireless communication terminal of the calling side UA10 and the wireless communication terminal of the called side UA20 cannot connect to the circuit switching network (including a case having no such function), information for selecting a wireless communication system to connect the calling side and the called side is exchanged via predetermined wireless communication systems (RNET1, RNET2) and the SIP server 300 before the start of the communication and switching of the wireless network is also performed between the SIP server 300 and the terminal before the start of the communication. Therefore, it is possible to communicate by use of the optimum wireless communication system (the wireless network RNET1, in this case) according to the conditions (wireless communication network, bandwidth, rate and the likes) of the wireless communication systems desired by the users at the calling side and the called side.

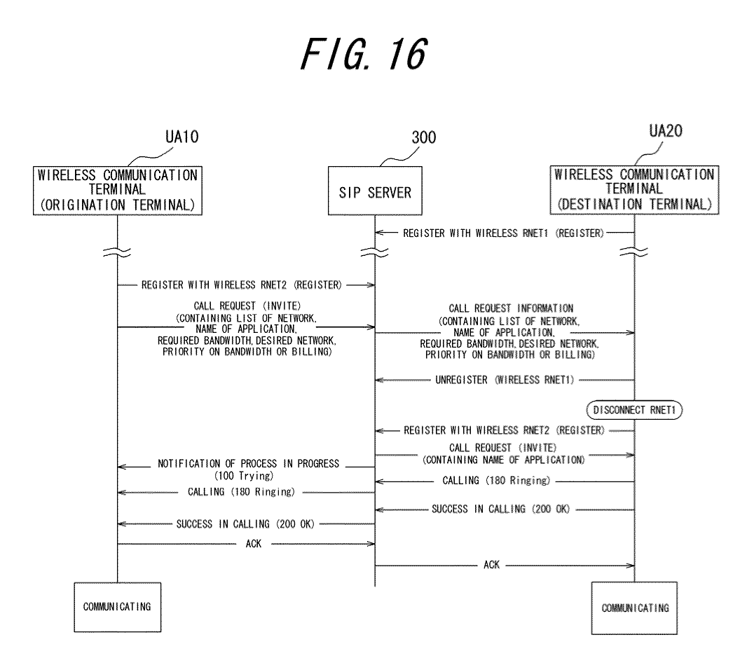

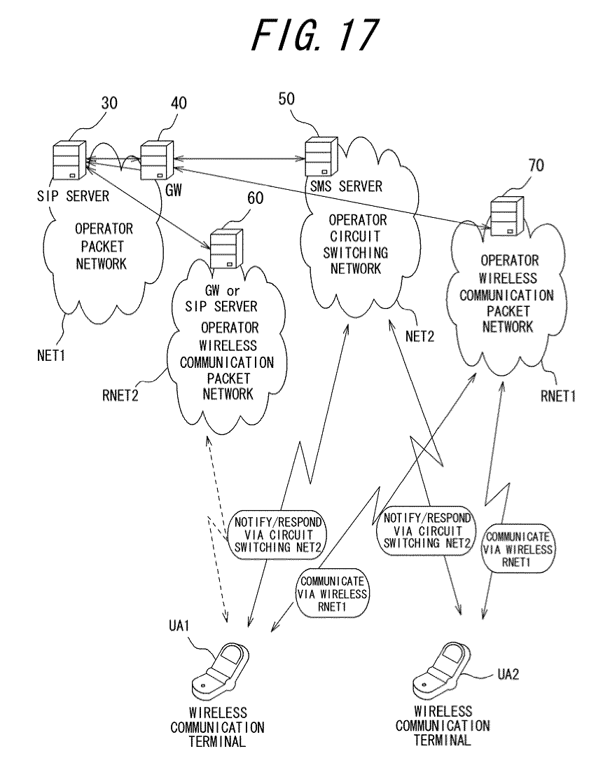

FIG. 16 is a sequence diagram illustrating communication control in accordance with the communication control method of the first embodiment when the wireless communication terminal of the calling side (origination terminal) UA10, which is incapable of connecting to the circuit switching network (including a case having no such function), calls the wireless communication terminal of the called side (destination terminal) UA20 and starts communication with the real-time application, in a case where the wireless communication terminal of the called side (destination terminal) UA20, which is incapable of connecting to the circuit switching network (including a case having no such function), registers to the SIP server 300 via the wireless network RNET1. FIG. 16 shows a case where the wireless communication terminal of the called side (destination terminal) UA20 is capable of switching to the wireless network (wireless network RNET2) desired by the wireless communication terminal of the calling side (origination terminal) UA10.

First, the origination terminal UA10 connects to (uses) the wireless network RNET2 and registers to the SIP server 300. In this case, the SIP server 300 follows the process shown as steps S01 to S03 in FIG. 6 and registers the address, the number and the name of the network of the terminal in the register memory table exemplified in FIG. 7. Next, the origination terminal UA10 transmits the call request (INVITE) for the destination terminal UA10 to the SIP server 300. As exemplified in FIG. 8, the call request (INVITE) includes the following information:
a list of wireless networks to which the wireless communication terminal of the calling side can connect: wireless networks RNET1, RNET2
a name of the application: videophone
a bandwidth necessary for the application: 500 kbps
a wireless network desired by the calling side: wireless network RNET2
information on whether “priority on bandwidth” or “priority on low rate”: “priority on bandwidth”

When the SIP server 300, upon receiving the call request (INVITE), confirms that although the destination terminal UA20 has registered, the wireless network (wireless network RNET1) to which the destination terminal UA20 connects is not the wireless network (wireless network RNET2) desired by the origination terminal UA10, the SIP server 300 stores the origination number, the destination number and the wireless network desired by the calling side (originator) as a desired call in the desired call memory table (the configuration of which is exemplified in FIG. 9). Then, the SIP server 300 follows the process shown as steps S11 to S13 and S16 shown in FIG. 11 and transmits the call request information to the destination terminal UA20. The same information as included in the call request (INVITE) is also included in the call request information.

When receiving the call request information from the SIP server 300, the destination terminal UA20 selects the wireless network RNET2 desired by the origination terminal UA10 as the wireless network to which the destination terminal UA20 connects, based on information in the call request information and the wireless network to which the destination terminal UA20 can currently connect, cancels the registration (UNREGISTER) with the wireless network RNET1, disconnects the wireless network RNET1, and then registers to the SIP server 300 with the wireless network RNET2. At this registration, when confirming that the destination terminal UA20 connects to the wireless network RNET2 (the wireless network desired by the origination terminal UA10) and registers therewith, the SIP server 300 transmits the call request (INVITE) to the destination terminal UA20. In this case, the SIP server 300 follows the process shown as step S01, step S02, step S03, Yes, step S04, Yes, step S05 in FIG. 6. Subsequently, the origination terminal UA10 and the destination terminal UA20 perform SIP procedures necessary for the call shown in FIG. 16 and start the communication with the real-time application.

According to the communication control method of FIG. 16, even when both of the wireless communication terminal of the calling side UA10 and the wireless communication terminal of the called side UA20 cannot connect to the circuit switching network (including a case having no such function), information for selecting a wireless communication system to connect the calling side and the called side is exchanged via the predetermined wireless communication systems (RNET1, RNET2) and the SIP server 300 before the start of the communication and switching of the wireless network is performed between the SIP server 300 and the terminal before the start of the communication. Therefore, it is possible to communicate by use of the optimum wireless communication system (the wireless network RNET1, in this case) corresponding to the conditions (wireless communication network, bandwidth, rate and the likes) of the wireless communication systems desired by the users at the calling side and the called side.

1. A wireless communication apparatus capable of using a plurality of different wireless communication systems comprising:
a transmission unit for transmitting a call request including information on a condition of a wireless communication system desired by a calling side by use of a predetermined wireless communication system; and
a control unit for controlling, when information indicating that a called side uses a wireless communication system not satisfying the condition of the wireless communication system desired by the calling side is received in response to the call request transmitted by the transmission unit, to retransmit the call request based on the received information on the wireless communication system used by the called side by use of another wireless communication system different from the predetermined wireless communication system.

2. A server apparatus comprising:
a reception unit for receiving a call request including information on a condition of a wireless communication system desired by a calling side;
a notification unit for notifying a called side of the information on the condition of the wireless communication system desired by the calling side in response to the call request received by the reception unit; and
a control unit for controlling, when information indicating that the called side uses a wireless communication system satisfying the condition of the wireless communication system desired by the calling side is received in response to notification by the notification unit, to transmit the call request to the called side.

3. The server apparatus according to claim 2, wherein the control unit controls, when information indicating that the called side uses a wireless communication system not satisfying the condition of the wireless communication system desired by the calling side is received in response to notification by the notification unit, to notify the calling side of information on the wireless communication system used by the called side and not to transmit the call request to the called side.
